(19) United States
(12) Patent Application Publication
(10) Pub. No.: US 2010/0005976 A1
(43) Pub. Date: Jan. 14, 2010

(54) Cooking top with optimized flame distribution

(76) Inventor: Enzo Inzaghi, Coneglianco (IT)

Correspondence Address: HEDMAN & COSTIGAN P.C., 1185 AVENUE OF THE AMERICAS, NEW YORK, NY, 10036, US

(21) Appl. No.: 11/919,647

(22) PCT Filed: Oct. 14, 2005
(86) PCT No.: PCT/EP2005/011174

§ 371 Date: Dec. 19, 2007

(30) Foreign Application Priority Data
May 11, 2005 (IT) MI2005A000837

(51) Int. Cl. A47J 27/00; F24C 3/08

(52) U.S. Cl. 99/444; 126/39 E

(57) ABSTRACT

A cooking top (10) comprises one or more gas cooking plates (11) equipped with burners (40) and a basin (20) for collecting the drips and food residues. According to the invention, said basin (20) comprises a perimetric edge (50) equipped with holes (23) for the passage of feeding means (26, 45) of said burners (40) and comprises a central region (51) equipped with a substantially continuous surface.

The present invention relates to a cooking top with optimized flame distribution.

Cooking tops for stoves having a series of burners situated in the centre of cooking plates and equipped with underlying basins suitable for collecting drips and food residues overflowing from cooking containers, have been known for some time.

Said basins generally consist of a shaped surface in which there are openings which allow the housing of burners and in particular gas feeding tubes. Around said openings a suitable shaping makes the surface suitable for receiving cooking plates.

Said burners are generally round-shaped and have a series of holes, notches or slits along the circumference for the outlet of gas, flame-distributors, through which the flame is distributed for heating the bottom of the container.

According to the known art, therefore, both the plate and the basin have a central hole with relatively large dimensions, through which the burner passes, which in this area has an expansion vessel which is in turn covered by a top having flame-distributor notches.

This configuration of the cooling plate has its drawbacks.

Firstly, the cleaning of the basin is laborious due to the encumbrance of the burner which passes through it.

Furthermore, when the cooking plates are removed to clean the drips and food residues which have overflowed from the containers during cooking, the surfaces of the basin are interrupted by the presence of the burners, or, if they are of the removable type, by the presence of openings for their housing. This discontinuity makes the cleaning of the whole basin not only particularly difficult but also inefficacious in the areas surrounding the discontinuity. If the burners are of the removable type, there is also the risk of part of the detergent running into the bottom of the cooking top through the openings which house the burners.

Another drawback lies in the limited possibility of correctly distributing the flame with a variation in the maximum heating capacity to be obtained in a burner. In this configuration, the maximum capacity of the flame is directly correlated to the diameter of the burner, by increasing this diameter however, an increasingly vast flameless central zone is created, jeopardizing the flame distribution underneath the container.

The maximum capacity of a burner, moreover, is limited by the maximum dimensions which can be produced, it is important to remember that the cooking top, in addition to functional limitations, is also subject to aesthetic limitations and, as it must house several burners, these must be dimensionally compatible and have a pleasant aesthetic appearance.

A general objective of the present invention is therefore to overcome the above disadvantages of the known art by providing a cooking top with an optimized flame distribution and with a high and concentrated capacity in Kcal/h.

Another objective of the present invention is to provide a cooking top in which the cleaning of the collecting basin of the drips and food residues can be effected simply and effectively.

Also included in the objectives of the present invention is that of providing a cooking top equipped with interchangeable elements with an optimized heating capacity in relation to the encumbrance.

Further objectives of the present invention relate to providing a cooking top equipped with easily removable and washable cooking plates, which are resistant to the most exasperating conditions and modular for the production of cooking tops having various shapes.

In view of the above objectives, according to the present invention, a cooking top has been conceived, with optimized flame distribution, having the characteristics specified in the enclosed claims.

The structural and functional characteristics of the present invention and its advantages with respect to the known art will appear more evident from examining the following description, referring to the enclosed drawings, which illustrate a cooking top produced according to the innovative principles of the invention itself.

In the drawings:

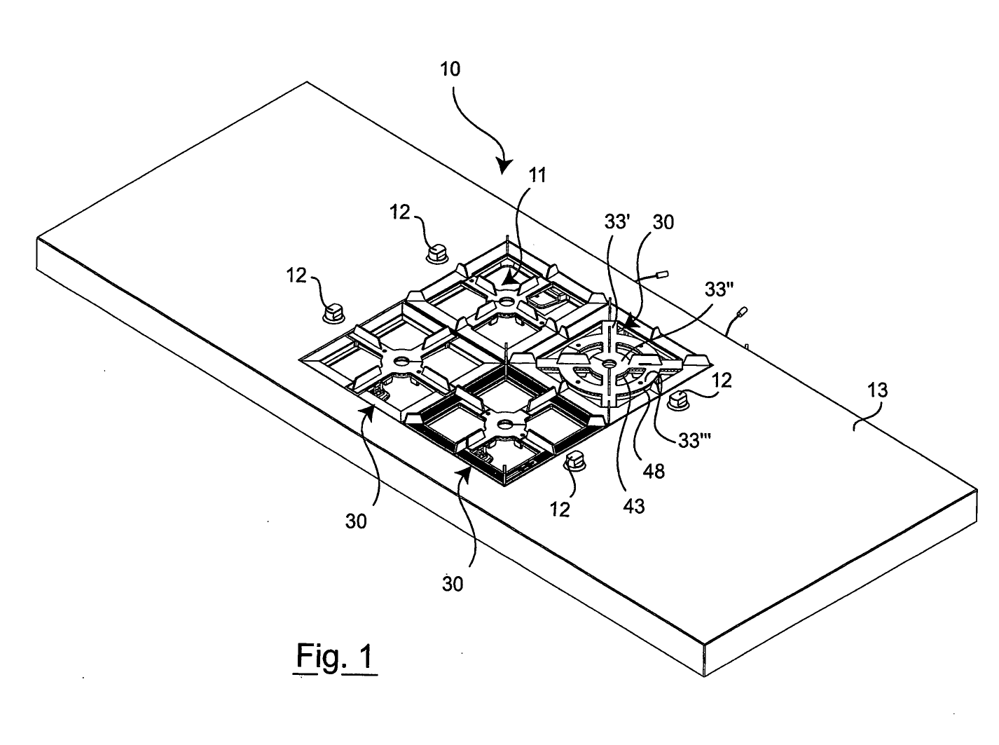

FIG. 1 is a perspective view of a cooking top according to the present invention;

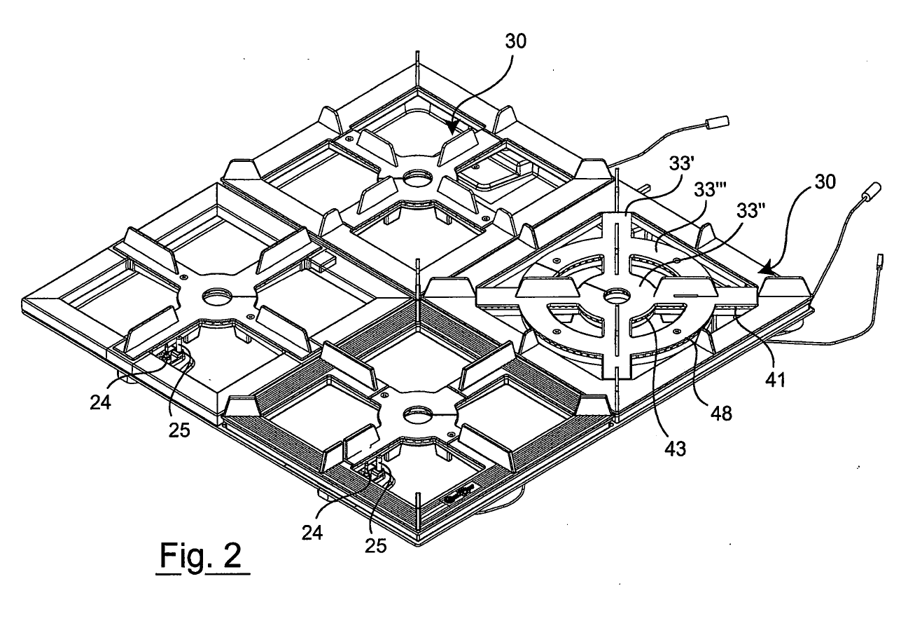

FIG. 2 is a perspective view of the four plates of the cooking top of FIG. 1;

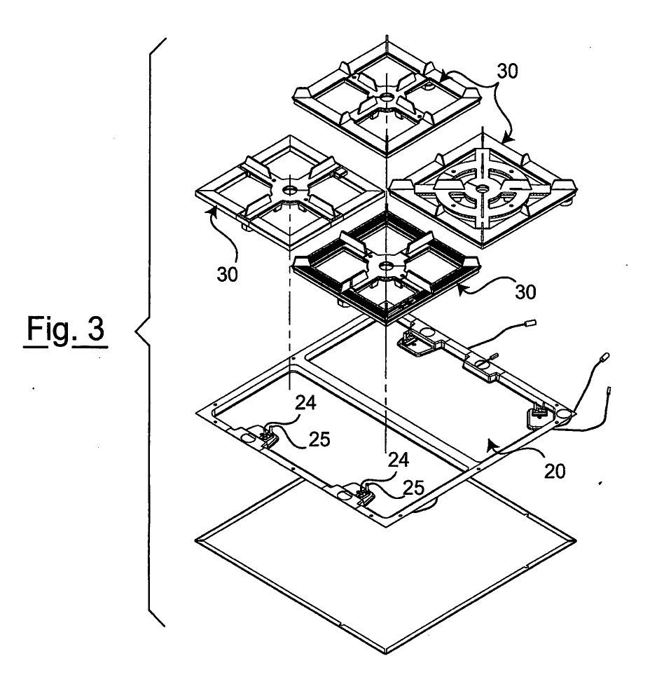

FIG. 3 is an exploded perspective view of the four plates of FIG. 2;

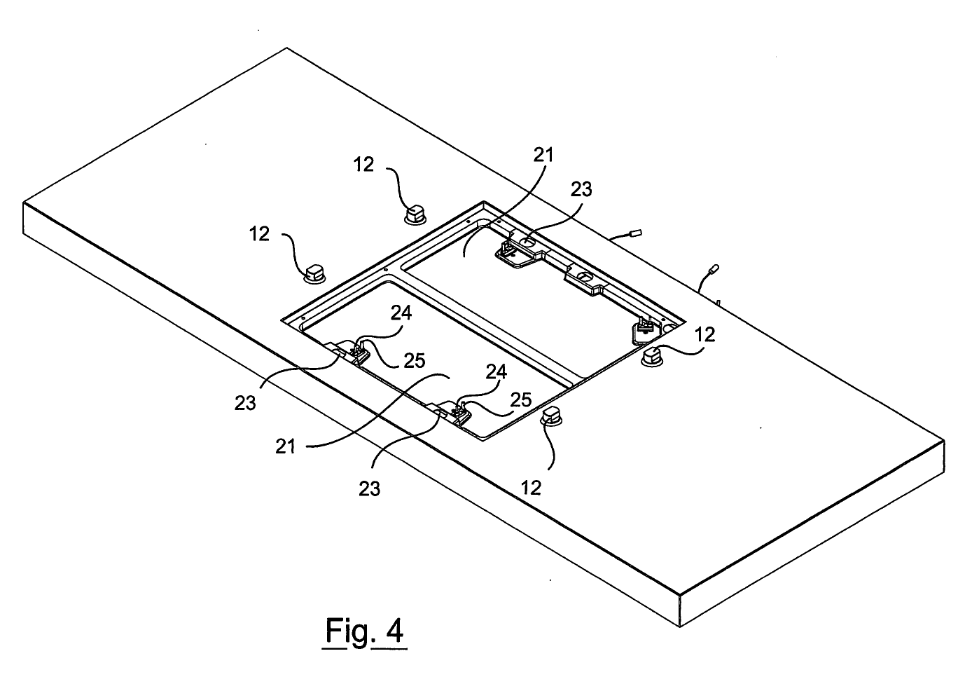

FIG. 4 is a perspective view of the basin of the cooking top of FIG. 1;

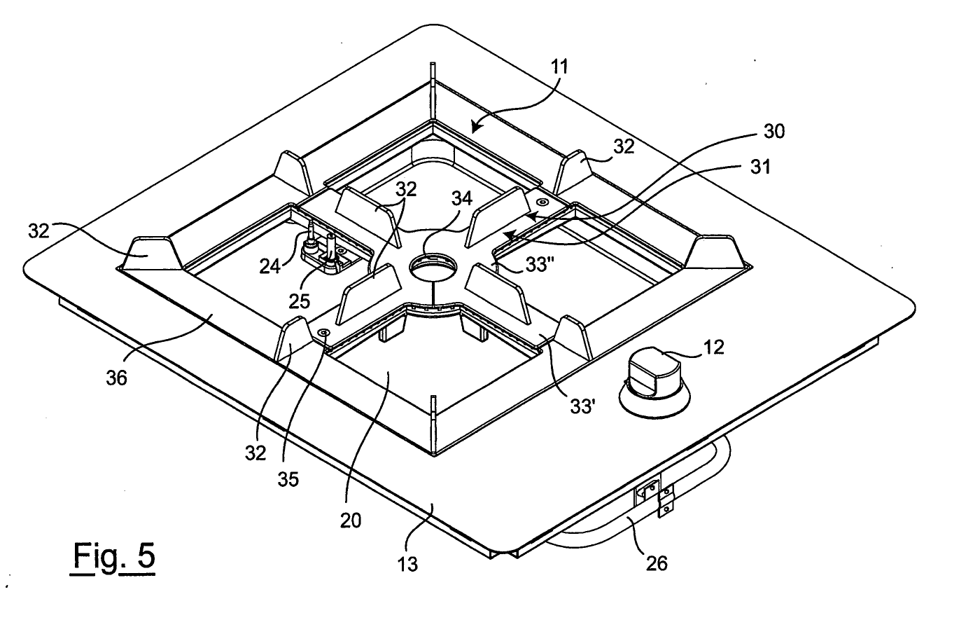

FIG. 5 is a perspective view of a modular cooking top according to the invention;

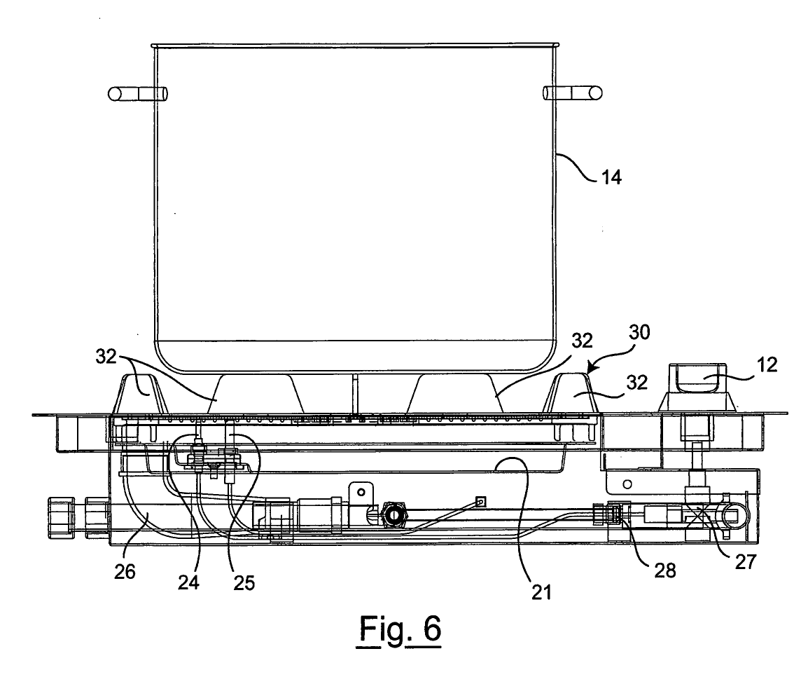

FIG. 6 is a raised schematic view of the plate of FIG. 5 with a saucepan on top;

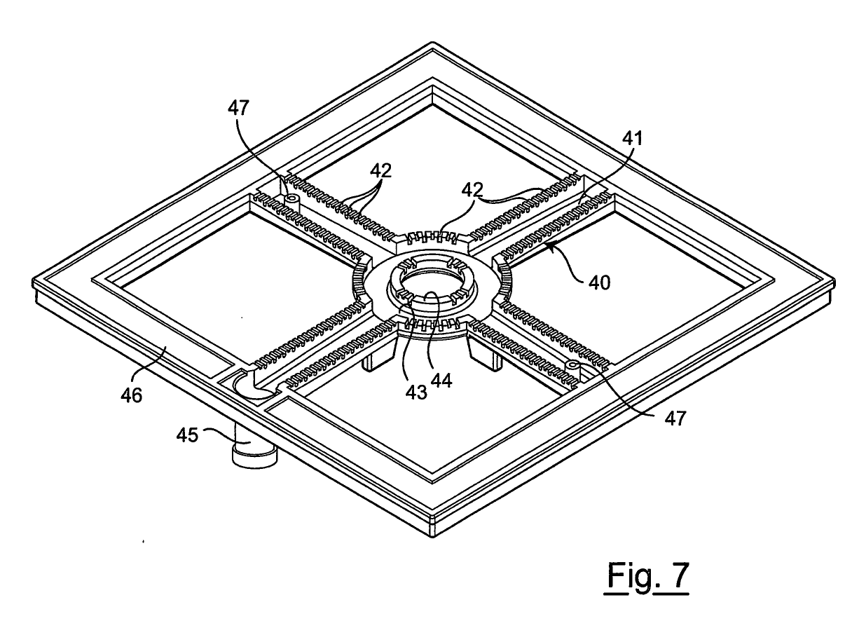

FIG. 7 is a perspective view of a detail of the plate of FIG. 5;

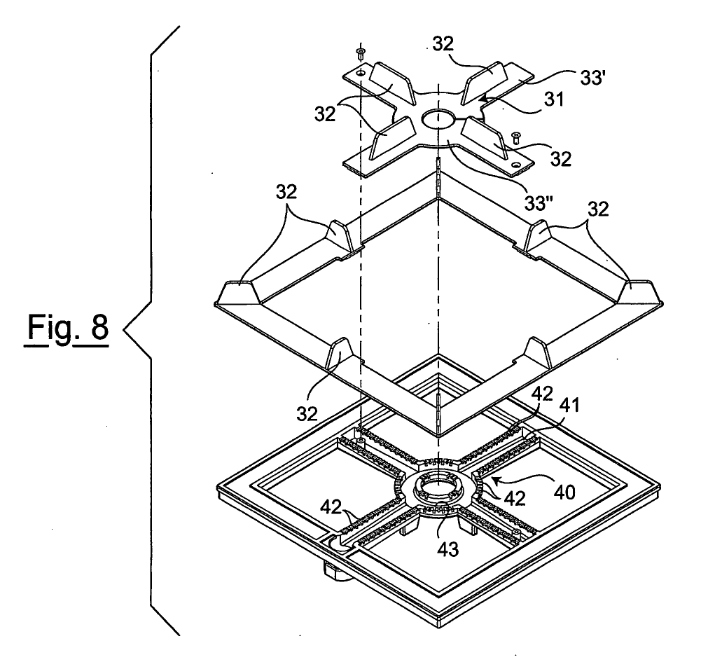

FIG. 8 is an exploded perspective view of a detail of the plate of FIG. 5;

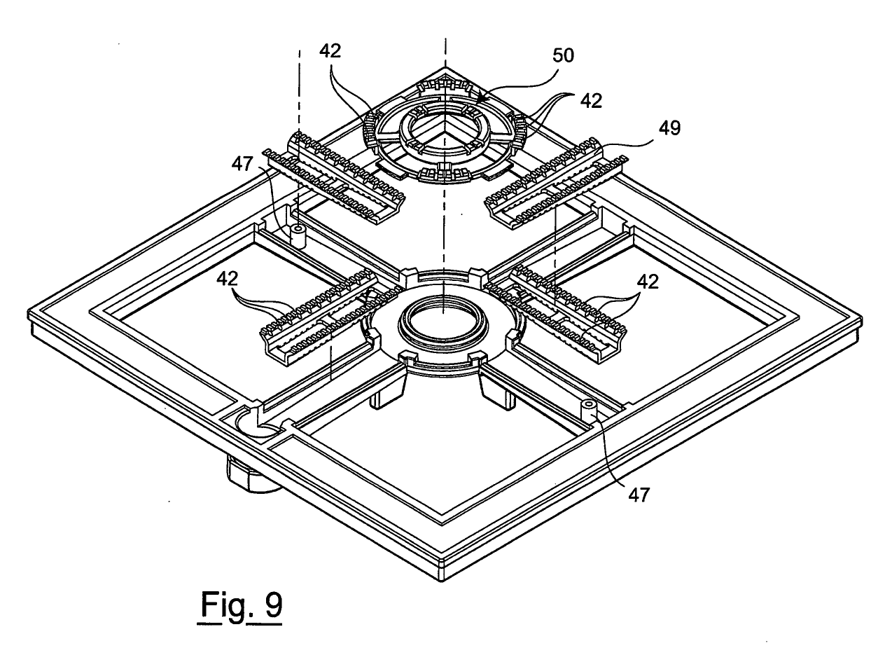

FIG. 9 is an exploded perspective view of a detail of a plate according to a different embodiment of the invention;

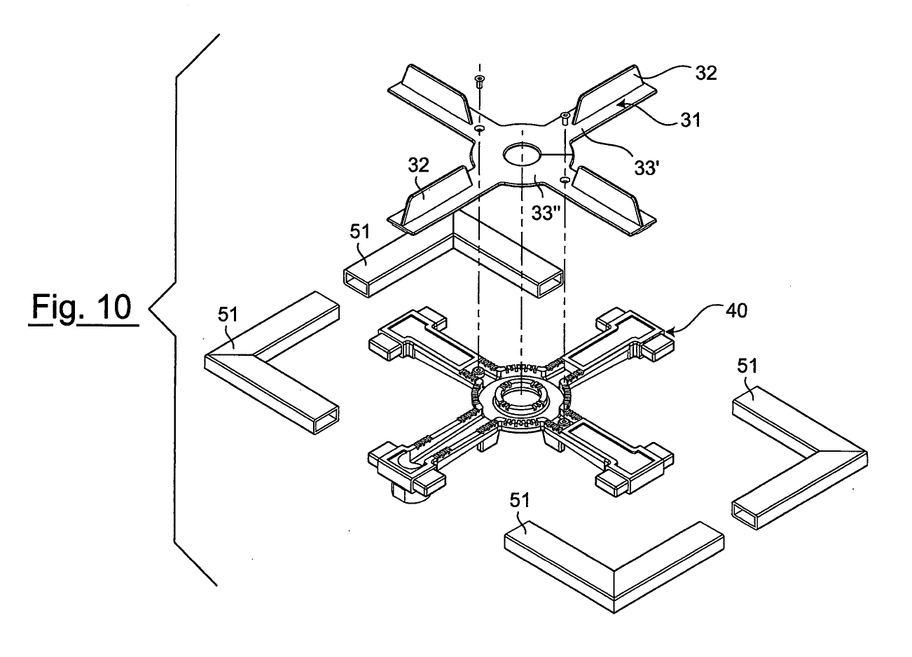

FIG. 10 is an exploded perspective view of a detail of a plate according to another embodiment of the invention.

With reference to the figures, a cooking top 10 comprises at least one cooking plate 11 fixed to a work top 13 of a cooking area or device.

Each cooking plate 11 comprises a supporting element 30 for cooking containers such as saucepans, frying pans and the like, generally indicated with 14 in FIG. 6, having an integrated burner base 40. The supporting element is situated on a basin 20 suitable for collecting possible drips and cooking food residues to prevent the fouling of the underlying items.

The basin 20 can be single for a series of modular cooking plates, for example four. Alternatively, the basin 20 can in turn be integrated with the cooking plate 11 and consequently only relate to said modular cooking plate.

In this case, when the modular plates 11 and relative basins are arranged on the cooking top 10, the basins are adjacent to each other so that the surface thus formed is without discontinuity in order to facilitate cleaning. For example, each basin can have shaped edges so as to overlap the edges of the adjacent basins maintaining the resulting surface flat and substantially continuous.

Said basin is therefore produced in the form of one or more bowls 21 separated by edges to limit the spreading of drips.

Close to the edge 50 which borders the perimeter of the basin, there are passage holes 23 for the feeding of gas, peripherally arranged in correspondence with each cooking plate to be assembled in the top. In this way, the basin has a continuous surface in its central region 51, i.e. free of openings which house burners or the presence of burners themselves.

In correspondence with each cooking plate, an ignition device 25 and a sensor 24 for the accidental leakage of gas, connected to the gas feeding line for its automatic division, are also envisaged in accordance with the regulations in force.

The cooking top 10 according to the present invention, is in fact suitable for the production of cooking appliances for household use such as that with four plates illustrated or for professional use in which large heating areas and/or large dimensions of a single plate, are required.

Each cooking plate 11 is equipped with peripheral gas feeding by afferent connection 45 to a burner base 40 integrated in the supporting element 30, said burner base 40 also comprises a burner crown 43 equipped with a central aeration hole 44.

Thanks to the combination of the supporting element 30 with the integrated burner base 40, the peripheral feeding and central aeration hole 44 of the crown 43, the cooking plate 11 can be rapidly removed allowing the perfect cleaning of the underlying basin 20.

The optimization of the flame distribution and combustion is also obtained as a result of the crown configuration 43 and air supply through the central aeration hole 44.

The cooking plate 11 therefore comprises a burner base 40 configured so as to include a cross of radial channels 41 intersecting and extending from the central crown 43.

Channels and crown have a “U”-section whose fins are regularly notched to form a flame-distributor 42 for the gas outlet. An outer frame 46 supports the cross of radial channels.

At the end of one of said radial channels 41 in a peripheral position with respect to the cooking plate, there is also a connection 45 suitable for contacting a gas feeding tube 26 which is “U”-shaped for indifferently allowing a bilateral feeding for each assembly position of the plate.

The plate is equipped with a knob 12 suitable for activating a gas feeding valve 27.

With particular reference to FIG. 6, this also illustrates the piezoelectric device 25 and the accidental gas leakage sensor 24 connected to the valve 27 by means of the switch-off actuator 28.

The burner base 40 also comprises at least one pair of internally threaded seats 47 for the screwing of the lid 31 of the supporting element 30 suitable for closing the channels and crown.

The lid 31 is configured so as to correspond to the burner base. In this respect, it has radial portions 33′ along which there are holes 35 corresponding to said threaded seats 47, and a coronal portion 33″ equipped with a central hole 34 corresponding to the central hole 44 of the burner base 40.

With particular reference to FIGS. 1 and 2, in order to obtain a greater heating capacity, it is possible to provide a cooking plate equipped with several concentric crowns which, with the same outer dimensions, guarantee a greater gas and therefore flame emission.

In this case, outside the first crown 43, there is a second crown 48 and, correspondingly, the lid 31 has a second coronal portion 33′″.

This is obviously only one of the possible configurations for obtaining a wider extension of the channels and consequently a greater heating capacity, at the same time maintaining the outer dimensions of the cooking plate unaltered.

The element 30 has fins 32 for supporting the cooking containers in a raised position with respect to the burner, these fins are envisaged so as to extend from both the lid 31 and from a perimetric top 36 which covers the corresponding frame 46 of the burner base 40.

With reference to FIG. 9, in a different embodiment of the invention, there are flame-distributor elements 49 and 50 to be respectively positioned along the radial channels 41 and on the crown 43, and optionally, even if not illustrated, corresponding flame-distributors to be positioned in the second crown 48.

These flame-distributor elements are conveniently made of brass as the high structural characteristics of these alloys allow use under much more drastic conditions than aluminum alloys.

According to a different embodiment illustrated in FIG. 10, a cooking plate with an adjustable geometry is equipped with edges 51 to be assembled on the cross of the burner base to allow assembly in varying configurations.

Furthermore, with reference to the figures, these demonstrate how a cooking top according to the invention is particularly useful and advantageous. The objective mentioned in the preamble of the description is therefore achieved.

The forms of the cooking top according to the invention can naturally differ from those shown for purely illustrative and non-limiting purposes in the drawings.

The protection scope of the invention is therefore delimited by the enclosed claims.

1) A cooking top (10) comprising:
one or more gas cooking plates (11) equipped with burners (40);
a basin (20) for collecting drips and food residues;
characterized in that said basin (20) comprises a perimetric edge (50) equipped with holes (23) for the passage of feeding means (26, 45) of said burners (40) and comprises a central region (51) equipped with a substantially continuous surface.

2) The cooking top (10) according to claim 1, characterized in that each cooking plate is equipped with a connection (45) in a peripheral position suitable for contacting a gas feeding tube (26) for allowing the removal of the cooking plate.

3) The cooking top (10) according to claim 1, characterized in that underneath said one or more cooking plates (11) there is at least one basin (20) for collecting drips overflowing from the cooking containers (14), equipped with gas feeding passage holes (23), arranged peripherically in correspondence with each cooking plate to be assembled in the top, the basin (20) being centrally free of obstacles.

4) The cooking top (10) according to claim 1, characterized in that each cooking plate comprises said burner base (40) configured so as to comprise a cross of radial channels (41) intersecting and extending from the central crown (43).

5) The cooking top (10) according to claim 4, characterized in that each cooking plate also comprises a second crown (48) externally concentric to the crown (43).

6) The cooking top (10) according to claim 4, characterized in that each cooking plate comprises in the supporting element (30) a lid (31) which can be fixed to said burner base (40) and configured so as to correspond to the burner base, having radial portions (33′) and at least one crown portion (33″).

7) The cooking top (10) according to claim 6, characterized in that said lid (31) also comprises a second crown portion (33′″).

8) The cooking top (10) according to claim 1, characterized in that said supporting element (30) comprises fins (32) extending upwards to support the cooking containers.

9) The cooking top (10) according to claim 1, characterized in that said gas feeding tube (26) of the cooking plate is “U”-shaped to indifferently allow a bilateral feeding for any assembly position of the plate.

10) The cooking top (10) according to claim 1, characterized in that said burner base (40) has in the channels (41) and central crowns (43) and second crown (48), a flame-distributor (42) for gas emission.

11) The cooking top (10) according to claim 1, characterized in that said burner base (40) has flame-distributor elements (49, 50) made of brass, to be positioned along the radial channels (41) and in the crown (43, 48).

12) The cooking top (10) according to claim 1, characterized in that a cooking plate with a modifiable geometry is equipped with edges (51) to be installed on the cross of the burner base (40) so as to allow assembly in varying configurations.
